(19) United States
(12) Patent Application Publication
(10) Pub. No.: US 2021/0012394 A1
(43) Pub. Date: Jan. 14, 2021

(54) ONLINE MEDIATION PLATFORM

(71) Applicant: James Tolley, Paia, HI (US)

(72) Inventor: James Tolley, Paia, HI (US)

(21) Appl. No.: 16/923,872

(22) Filed: Jul. 8, 2020

Related U.S. Application Data
(60) Provisional application No. 62/871,313, filed on Jul. 8, 2019.

(51) Int. Cl. G06Q 30/02; G06Q 50/00; G06Q 50/18

(52) U.S. Cl. CPC G06Q 30/0279; G06Q 50/188; G06Q 50/182; G06Q 50/01

(57) ABSTRACT

Systems, methods, and storage media for creating an argument map for an argument via an online mediation platform are disclosed. Exemplary implementations may: receive, via the online mediation platform, a request to mediate the argument from a claimant; provide a crowdfunding interface configured to facilitate a crowdfunding campaign associated with the argument; negotiate, via the online platform, selection of at least two parties to a mediation of the argument; negotiate, via the online platform, compensation for one or more of the at least two parties; negotiate, via the online platform, appointment of at least one mediator; provide a submission interface configured to receive submissions of proposed argument nodes; and provide a submission interface configured to allow the at least one mediator to accept, reject, or edit the submissions.

### CROSS REFERENCE TO RELATED APPLICATIONS

The present application claims the benefit of priority to U.S. Provisional Application No. 62/871,313, filed Jul. 8, 2019, the entire disclosure of which is claimed herewith.

### FIELD OF THE DISCLOSURE

The present disclosure relates to systems, methods, and storage media for creating an argument map for an argument via an online mediation platform.

### BACKGROUND

“Shared Reality” is needed for society to function and for an electorate to effectively move their democracies forward. Presently, different news and opinion sources communicate contradictory information. The public lacks clarity and is divided, threatening our very system of government. There is a need for resources, systems, and methods to help resolve disinformation and public confusion about contemporary debates and arguments to effectively create a Shared Reality everyone can believe in. Moreover, critical decades-old controversies are never resolved because society does not have a reliable source of information which all stakeholders consider credible and relevant. Alternative truth-discovery processes such as court trials are too slow and cumbersome—and are not always appropriate—to meet our current needs. Therefore, a need exists to remedy these shortfalls.

### SUMMARY

One aspect of the present disclosure relates to a system configured for creating an argument map for an argument via an online mediation platform. The system may include one or more hardware processors configured by machine-readable instructions. The processor(s) may be configured to receive, via the online mediation platform, a request to mediate the argument from a claimant. The processor(s) may be configured to provide a crowdfunding interface configured to facilitate a crowdfunding campaign associated with the argument. The processor(s) may be configured to negotiate, via the online platform, selection of at least two parties to a mediation of the argument. The processor(s) may be configured to negotiate, via the online platform, compensation for one or more of the at least two parties. The processor(s) may be configured to negotiate, via the online platform, appointment of at least one mediator. The processor(s) may be configured to provide a submission interface configured to receive submissions of proposed argument nodes. The processor(s) may be configured to provide a submission interface configured to allow the at least one mediator to accept, reject, or edit the submissions. Argument map interface configured to display accepted and edited submissions as child nodes on the argument map.

Another aspect of the present disclosure relates to a method for creating an argument map for an argument via an online mediation platform. The method may include receiving, via the online mediation platform, a request to mediate the argument from a claimant. The method may include providing a crowdfunding interface configured to facilitate a crowdfunding campaign associated with the argument. The method may include negotiating, via the online platform, selection of at least two parties to a mediation of the argument. The method may include negotiating, via the online platform, compensation for one or more of the at least two parties. The method may include negotiating, via the online platform, appointment of at least one mediator. The method may include providing a submission interface configured to receive submissions of proposed argument nodes. The method may include providing a submission interface configured to allow the at least one mediator to accept, reject, or edit the submissions. The argument map interface configured to display accepted and edited submissions as child nodes on the argument map.

Yet another aspect of the present disclosure relates to a non-transient computer-readable storage medium having instructions embodied thereon, the instructions being executable by one or more processors to perform a method for creating an argument map for an argument via an online mediation platform. The method may include receiving, via the online mediation platform, a request to mediate the argument from a claimant. The method may include providing a crowdfunding interface configured to facilitate a crowdfunding campaign associated with the argument. The method may include negotiating, via the online platform, selection of at least two parties to a mediation of the argument. The method may include negotiating, via the online platform, compensation for one or more of the at least two parties. The method may include negotiating, via the online platform, appointment of at least one mediator. The method may include providing a submission interface configured to receive submissions of proposed argument nodes. The method may include providing a submission interface configured to allow the at least one mediator to accept, reject, or edit the submissions. The argument map interface configured to display accepted and edited submissions as child nodes on the argument map.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for creating an argument map for an argument via an online mediation platform, in accordance with one or more implementations.

FIG. 2 illustrates a method for creating an argument map for an argument via an online mediation platform, in accordance with one or more implementation.

FIG. 3 illustrates an argument map on an interface of the platform according to an embodiment of the disclosure

FIGS. 4A and 4B depict a node and a node with a corresponding menu, respectively, according to an embodiment of the disclosure

### DETAILED DESCRIPTION

What is needed is a peer-review process for the news and current events. The systems of the present disclosure creates documents where the most compelling reasons and evidence in support of a perspective may be presented alongside the most relevant and credible rebuttals of those perspectives. In this way, stakeholders may be able to see what the best arguments for or against a perspective are, see who else believes what, and then make up their own minds, while having access to all information in the most user-friendly format possible. The system of the present disclosure provides a mediation platform (“the platform”) for completing an argument map and documentation for each mediation. An argument map is a tool used in philosophy and logic discussions for visually depicting structural components of an argument or a claim. An advantage of the platform is that it creates the most effective and complete record of an argument possible given the existing beliefs and evidence available for the particular argument. The argument map document type was developed specifically to clarify confusion. Argument maps exclude bias, innuendo, and logical fallacies by making them conspicuous and easy to remove, so that the best available arguments and evidence may be considered independently, based solely on their actual merits. The intent of the argument map is to provide a detailed record of what parties believe, and why they believe those things. No other final outcome is sought. Specifically, there is no expectation that parties will agree with each other regarding the claim of a mediation. Various rules described throughout this disclosure may be used to provide a framework for the use of the platform, but other rules may be implemented without departing from the scope of the present disclosure. The rules are intended to facilitate effective communication by minimizing confusion and distraction during the mediation process. They are also intended to output a conclusively authoritative record of belief on a given claim.

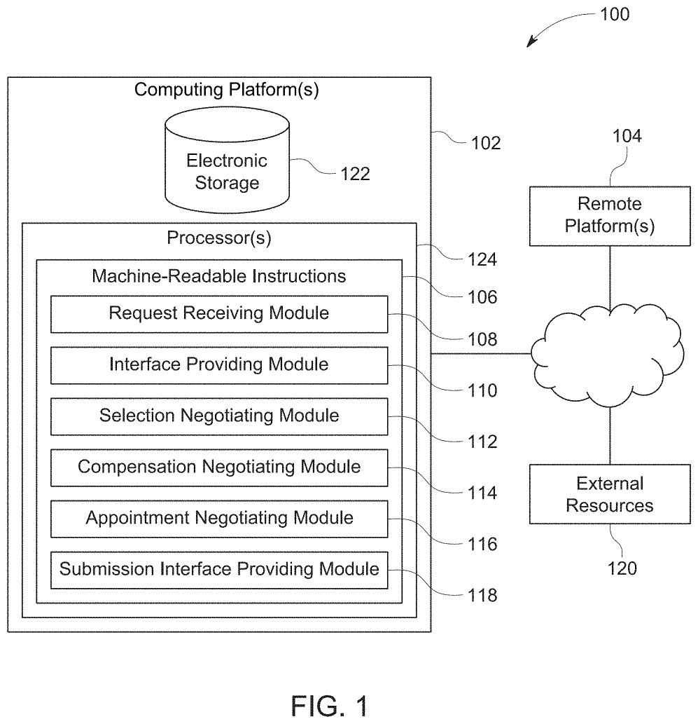

FIG. 1 illustrates a system 100 configured for creating an argument map for an argument via an online mediation platform, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of request receiving module 108, interface providing module 110, selection negotiating module 112, compensation negotiating module 114, appointment negotiating module 116, submission interface providing module 118, and/or other instruction modules.

Request receiving module 108 may be configured to receive, via the online mediation platform, a request to mediate the argument from a claimant. In the present disclosure, the term “mediation” may be used to describe all or part of the process of facilitating the creation of an argument map. An “argument” may be used to refer to any subject of debate, whether political, social, economic, interpersonal, scientific, factual, or any other type of topic on which humans may disagree. The term “claimant” may be used to refer to any individual or group of individuals who wish to submit a claim for mediation on the platform, and may be a member of the public, a potential participant in the mediation, a stakeholder in the outcome, or any or all of the above.

Interface providing module 110 may be configured to provide a crowdfunding interface configured to facilitate a crowdfunding campaign associated with the argument. The terms “crowdfunding” and “crowdfunding campaign,” as used herein, refer to methods of raising money from multiple individuals online for a particular defined cause or purpose. Crowdfunding campaigns exist for raising money for community projects, helping individuals in need, funding business ventures, and more. In the system of the present disclosure, crowdfunding may be used to promote participation from thought leaders, experts, and/or subjects of the debate. An advantage to the crowdfunding feature is that it can create public pressure and financial incentives for those connected to the debate to be accountable for their role in it and actually participate. For example, if a TV news personality makes a claim that many people dispute, thereby creating a public argument, a claimant may submit the claim and, upon acceptance by the platform, may initiate a crowdfunding campaign. The crowdfunding campaign may be designed to raise funds to pay the TV news personality to actually participate in the argument as a party, and therefore be accountable for his or her role in the public argument. Such a TV news personality would be encouraged to acknowledge and address the available public evidence which contradicts their assertions and characterizations. Raising money and offering it to a potential party to the mediation creates public pressure to respond. Such funds may also be used to promote public awareness of the mediation among the TV personality's viewing audience or the public at large, to locate other experts and then compensate them for their participation, or for other reasons in pursuit of the goal of creating a shared reality for everyone. As another example, a crowdfunding campaign to fund a mediation of a scientific debate (such as one about vaccines or climate change) may be used to pay large numbers of leading scientists in the field to weigh in. This removes an element of “hearsay”, bias, and cherry picking present in all current media reports written by non-experts. The goal would be documents of unimpeachable credibility, which come directly from the group who knows the most among us on a topic, without being presented through an intermediary such as a media conglomerate, journalist, lobbyist, pundit, politician, activist, etc. Such intermediaries may have their own agendas, unknown to the public, which skew their presentation of evidence and providing direct connection between the domain experts and the public removes any possibility of such distortion. Members of the public, as well as organizations who are interested in having complex debates documented in clear structures as a basis for a shared reality may contribute to these crowdfunding campaigns.

An aspect of the disclosure provides for one or more parts of a negotiation to be implemented by the platform. For selection of parties, selection negotiating module 112 may be configured to negotiate, via the online platform, selection of at least two parties to a mediation of the argument. This may be done by receiving a plurality of parties into the system by the nomination of claimants or other participants in the platform and conducting exchanges of communication between the potential parties and the mediator or administrator. The crowdfunding interface configured to facilitate the crowdfunding campaign may further include an interface configured to receive preferences from funders (i.e., members of the public or organizations with an interest in the outcome) regarding one or more aspects of the mediation. For example, the funders may indicate who they would like the parties to be, how they would like the parties to be compensated, who should mediate, and what topics they would like to see addressed, to give a few non-limiting examples.

The at least two parties may include one or more of nominating parties and invited parties. “Nominating parties” may be individuals or groups who are parties to a mediation who nominate other individuals or groups to substantively participate in submitting nodes of an argument. “Invited parties” may be those nominated by the Nominating Parties. Say, for example, a public argument around the topic of Climate Science involves two politicians, each of whom represents a different side of the issue. Neither politician has a first-hand understanding of the topic at hand and therefore would not be an appropriate Party to a Mediation on that topic. A claimant and a group of funders who want to achieve clarity on this topic through a mediation on the platform may specify the these politicians, however, to act as Nominating Parties to the Mediation. As a result, each politician (a.k.a. Nominating Party) would nominate their own thought leaders—those whose opinions inform their own—who do have such first-hand knowledge and expertise. These thought leaders would act as Invited Parties to the Mediation, and act as its co-authors, perhaps along with other Climate Scientists of a similar level of influence who might also provide important relevant insights, perspectives, challenges, rebuttals, etc., around the Mediation's topic. The nomination and invitation features may be facilitated through the negotiation module.

The crowdfunding campaign may be configured to distribute funds to at least one of the at least two parties. As previously described, the funds may be used to incentivize the invited parties to participate. Or, at least ensuring that all important perspectives are included in the resulting argument map document so that the document is relevant to all stakeholders, who would be able to see their own perspectives included, and perhaps rebutted by those best in a position to offer the most persuasive rebuttals to those perspectives. In the example of politicians on two sides of an issue, a mediation may be requested by ordinary citizens on the platform because they are confused about and tired of hearing two politicians trading talking points on two sides of an issue that appear to be completely contradictory and not rooted in the same shared reality. These citizens, tasked with moving their democracy forward via their collective votes, may have an interest in seeing the whole argument mapped out in a clear, complete, and unbiased way from both sides, including the most persuasive supporting evidence, so that they may make truly informed decisions. The bounds of consensus, in this way, can be made explicit while areas of continued contention are detailed according to the reasons and evidence causing those contentions to persist. Voters may be incentivized to fund this mediation and argument map because they believe it will vindicate their point of view, for entertainment value, or to ensure that their perspectives are correct. In this case, if the associated crowdfunding campaign raised a million dollars, the funds could be allocated to each of the politicians to incentivize them, either by paying them, their proxies/surrogates, or creating public awareness around previous public statements of one or both participants, or others, to invest the time necessary to substantively participate in the mediation. If other parties, such as experts, are also invited to participate, they may receive a portion of the raised funds as well.

Compensation negotiating module 114 may be configured to negotiate, via the online platform, compensation for one or more of the at least two parties. Or, it could pay a “curator”, or “author” who simply created the argument map based on statements available in the public record.

Appointment negotiating module 116 may be configured to negotiate, via the online platform, appointment of at least one mediator. It is contemplated that different individuals with subject matter expertise in different fields may be best suited to mediate particular mediations. There may be many available mediators for a particular mediation, or a new one may need to be requested or invited, which may be done through the appointment negotiating module 116.

Submission interface providing module 118 may be configured to provide a submission interface configured to receive submissions of proposed argument nodes. The submission interface may comprise one or more input forms available to the parties to a mediation. Argument nodes may comprise discrete portions of a particular argument.

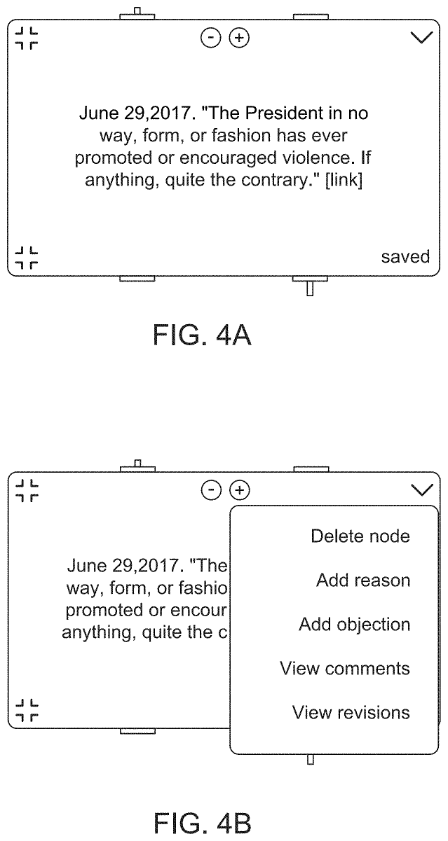

Turning briefly to FIGS. 4A and 4B, shown are exemplary nodes of an argument map of the present disclosure. FIG. 4A shows a single argument node, which comprises several elements. As shown, there are the “ports” or “endpoints” on the top of the node, which will connect to the connectors, which connect the node to the parent node (or parent nodes, if there is more than one parent). There are also the “+” and “−” circles at the top in the middle. These are for experts to vote on whether they believe the claim, reason, or objection of the node. The node further comprises the node content, which is the discrete position of a particular argument. FIG. 4A also shows, in the upper- and lower-left corners, links to collapse or expand the descendants or the ancestors, which toggles their visibility. In the lower right corner there is a status label. In this case, it lets the user know that it's saved, but there could be other status messages here or elsewhere. There are also “ports” or “endpoints” at the bottom, connecting to child nodes. At the top right of the node, there is a menu drop-down icon.

FIG. 4B shows a node with a menu displayed, where different options are available, to view comments or revisions, add a child element, delete the node, etc. In embodiments, there may be another node element describing whether the node was a logical fallacy. There may also be a place in the node to show the username of the author of the node. In embodiments, authors may be unable edit each other's nodes.

Submission interface providing module 118 may be configured to provide a submission interface available to the mediator to allow the at least one mediator to accept, reject, or edit the submissions. The submission interface (or another mediator-facing portion of the interface) may be further configured to receive an instruction from the at least one mediator to close the mediation. The argument map interface configured to display accepted and edited submissions as child nodes (otherwise referred to simply as “nodes”) on the argument map. The argument map interface may be configured to publicly display a completed version of the argument map. In embodiments, the argument map interface may also configured to display argument maps that are in progress and not yet complete.

In some implementations, the request to mediate may include a preliminary argument map. This may be a draft argument map submitted by a claimant or one of the parties. In some implementations, the negotiating via the online platform may further include negotiation of terms of a mediation of the argument.

In some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100. External resources may be validated and authenticated as the original resource referenced in the mediation by storing an MD5 or similar “hash” value.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

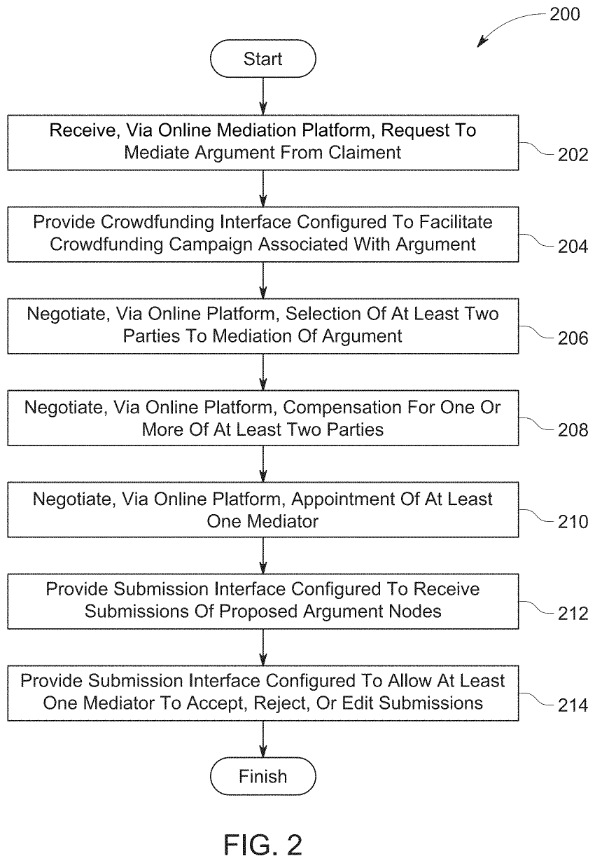

FIG. 2 illustrates a method 200 for creating an argument map for an argument via an online mediation platform, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving, via the online mediation platform, a request to mediate the argument from a claimant. Operation 202 may be performed by one or more hardware processors configured by machine-readable instructions including a module that is the same as or similar to request receiving module 108, in accordance with one or more implementations.

An operation 204 may include providing a crowdfunding interface configured to facilitate a crowdfunding campaign associated with the argument. Operation 204 may be performed by one or more hardware processors configured by machine-readable instructions including a module that is the same as or similar to interface providing module 110, in accordance with one or more implementations.

An operation 206 may include negotiating, via the online platform, selection of at least two parties to a mediation of the argument, or an author may use the public record to create the argument map, inviting parties to verify/disown/elaborate on their previous public statements. Operation 206 may be performed by one or more hardware processors configured by machine-readable instructions including a module that is the same as or similar to selection negotiating module 112, in accordance with one or more implementations.

An operation 208 may include negotiating, via the online platform, compensation for one or more of the at least two parties. Operation 208 may be performed by one or more hardware processors configured by machine-readable instructions including a module that is the same as or similar to compensation negotiating module 114, in accordance with one or more implementations. Or, funds can be allocated for different purposes meant to forward the creation of a universally authoritative and conclusive document.

An operation 210 may include negotiating, via the online platform, appointment of at least one mediator. Mediators may not be present. Invited Parties (say, 20 randomly selected members on the platform) may just police/mediate each other. Operation 210 may be performed by one or more hardware processors configured by machine-readable instructions including a module that is the same as or similar to appointment negotiating module 116, in accordance with one or more implementations.

An operation 212 may include providing a submission interface configured to receive submissions of proposed argument nodes. Operation 212 may be performed by one or more hardware processors configured by machine-readable instructions including a module that is the same as or similar to submission interface providing module 118, in accordance with one or more implementations.

An operation 214 may include providing a submission interface configured to allow the at least one mediator to accept, reject, or edit the submissions. In embodiments, the mediation itself being conducted by a mediator may be optional. In such embodiments, artificial intelligence programs may be used to mediate statements to, for example, ensure that statements do not contain loaded language. Argument map interface configured to display accepted and edited submissions as child nodes on the argument map. Operation 214 may be performed by one or more hardware processors configured by machine-readable instructions including a module that is the same as or similar to submission interface providing module 118, in accordance with one or more implementations.

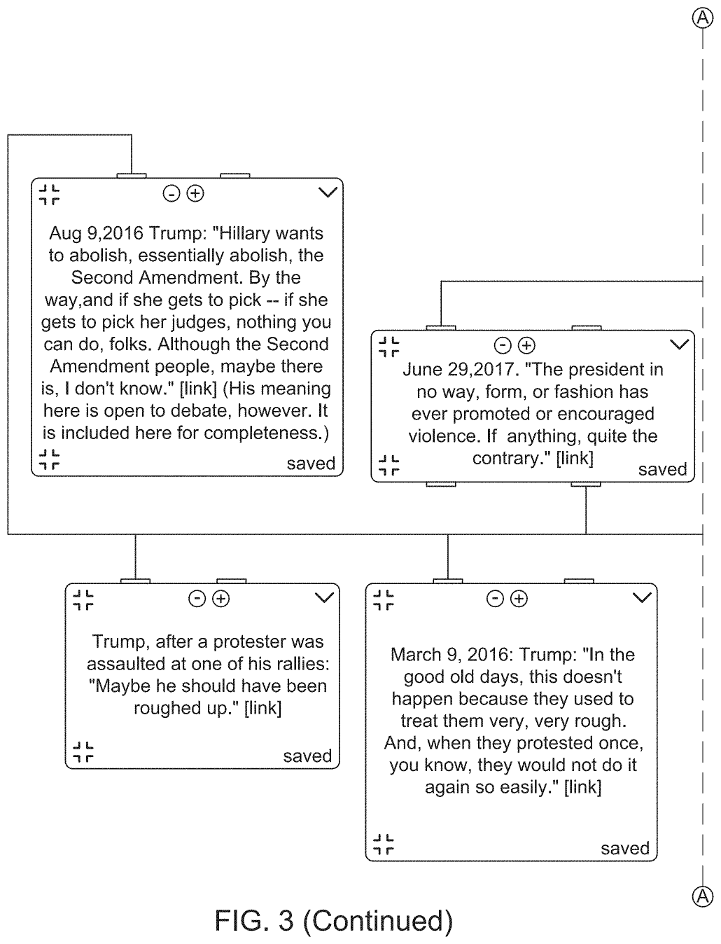

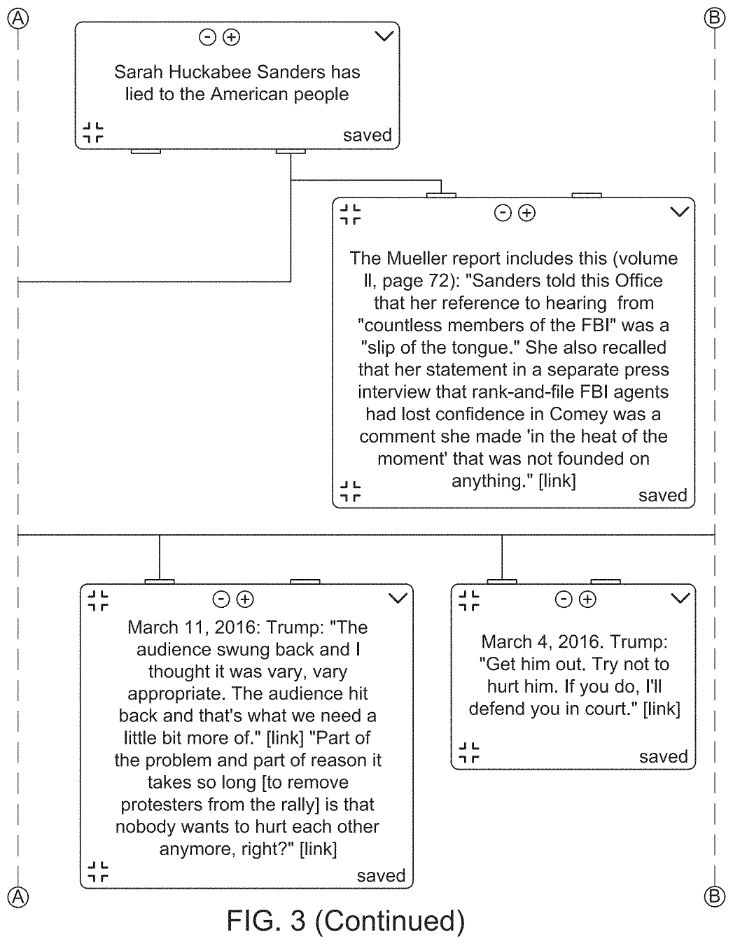

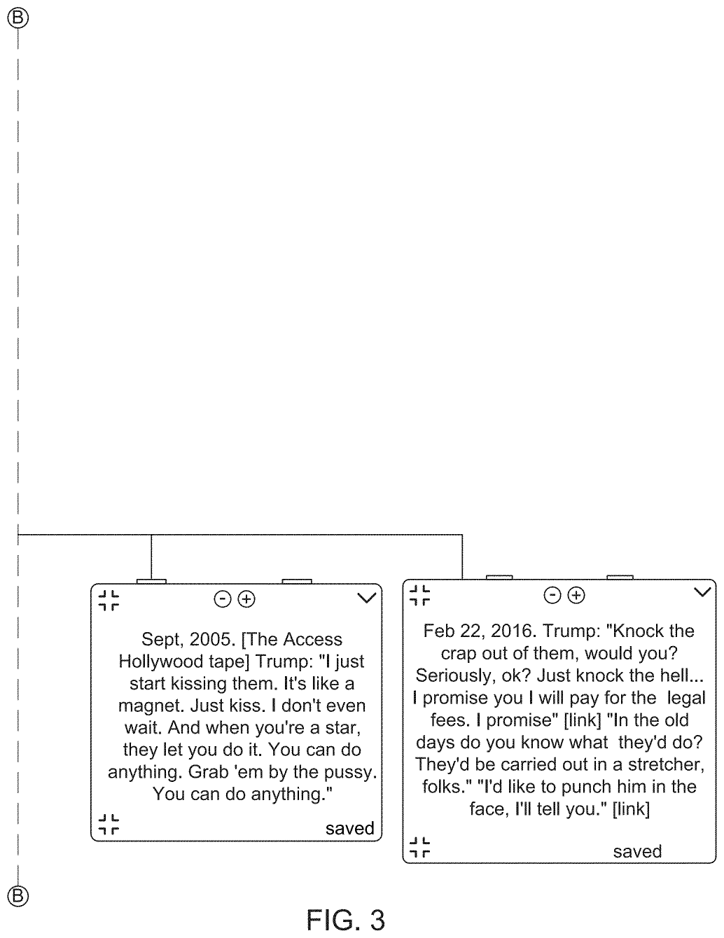

Turning now to FIG. 3, shown is an exemplary argument map, which may be displayed on an argument map interface of the platform. As shown, the argument has a parent node at the top, which is the claim of the particular argument map, a second level with two child nodes representing discrete portions of the argument, and a third level with several child nodes of one of the two child nodes of the second level. In embodiments, many more nodes and many more levels of an argument map may be present for any particular claim.

As described previously in this disclosure, sets of rules for implementing the platform of the present disclosure may provide a detailed framework for how the various participants in the mediation may interact with the platform. For the purposes of illustrating how a full mediation on the platform may work, the following exemplary mediation rules (which may be referred to as the capitalized term “Rules”) are provided. Different mediation rules may be implemented via the platform without departing from the scope of the present disclosure.

In embodiments of the mediation rules, The Mediator may resolve disputes about the interpretation and applicability of these Rules insofar as they relate to the Mediator's duties and responsibilities. All other Rules shall be interpreted and applied by the Administrator. Such resolutions by the Mediator or the Administrator shall be final.

Initiation of Mediation: Any Claimant may initiate a Mediation by submitting a Request to Mediate on the platform, as previously referenced in this disclosure.

The Administrator, on his or her own prerogative, shall either Accept or Deny the Request to Mediate, based on the following criteria:
1. The Claimant and all Invited Parties may be expected to have important first-hand knowledge or expertise regarding the Claim of the Request to Mediate, as evidenced by public statements made in any form, or other evidence. In the present disclosure, the term “claim” refers to the primary Claim of a Mediation, and the top-most, or root, Node in an Argument Map of the present platform. It is always the only Node in every Argument Map which does not have a Parent Node.
2. Nominating Parties and Invited Parties should all be sufficiently influential thought leaders regarding the Claim of the Request to Mediate, or they should be in a position to Nominate other Nominating Parties and Invited Parties who would be in such a position.
3. The Claim of the Request to Mediate should contribute practical value to public policy discussions, or must support other Claims which are significant to such discussions.
4. The Claim should be able to be supported or weakened/refuted by acceptable Evidence.
5. The stated objective of the Request to Mediate should be reasonably attainable.
6. Competing Claims should not already have been submitted or accepted on the Mediation Platform.
7. The thoroughness or otherwise compelling nature of the attached Preliminary Argument Map.

If the Claimant is not a sufficiently influential thought leader regarding the Claim, they may submit a Request to Mediate along with an optional Preliminary Argument Map document, but they may not become a Party to the Mediation, unless they become registered as an Assistant to one or more of the Parties to a Mediation.

The Administrator will notify the Claimant regarding the Acceptance or Denial of their Request to Mediate, along with the reasons for their decision. In the case that the Request to Mediate has been Denied, the Administrator may suggest a Remedy. Fulfillment of the suggested Remedy does not guarantee acceptance of future Requests for Mediation, although Acceptance by the Administrator should be considered likely.

Upon an Administrator's Acceptance of the Claimant's Request to Mediate, the Claimant and the Administrator shall send an Invitation to Mediate to each of the Nominating Parties and Invited Parties named in the Request to Mediate.

Negotiations may take place (via the negotiation module of the platform) in order to determine who will be among the Parties to the Mediation. These negotiations may involve the availability, requirements regarding compensation, levels of influence and regard around the Claim and expected Reasons and Objections, and other factors, at the Administrator's discretion. This process may result in a Negotiated Compensation Agreement for the Mediation, which may be signed by all Parties. During this process, crowdfunding for the Mediation may continue in order to support the creation of a decisive and consequential resulting Argument Map.

When the Claimant and at least one (1) of the Invited Parties have each submitted an Agreement to Mediate, the Administrator may conduct administrative conferences with the Parties in order to facilitate discussion and agreement on issues such as the selection of a Mediator, clarification and acceptance of Rules, and any other administrative matters.

Any other of the Invited Parties may submit a Request for Inclusion for the Mediation. All Parties to the Mediation and the Mediator must accept the Request for Inclusion in order for the Requesting Party to be granted access to the Mediation.

The Mediator may, at their sole discretion and for good cause, extend any time-frames established in these Rules or in the Parties' Agreement to Mediate.

Funds Raised: Funds raised may be allocated to the individual Parties, to the platform provider, to the Mediator, and to the Administrator, based on the Negotiated Compensation Agreement (negotiated through the negotiation module on the platform). Excess funds may either be returned to the Funders based on a percent remaining of the total funds raised, allocated to platform members' platform accounts in order to fund future platform Mediations, used to promote awareness of the mediation and its resulting argument map, or retained for some other use to be determined later.

Assistants: Any Party may use Assistants of their choice. Assistants shall be registered on the platform website using the Assistant Registration form prior to the Assistant's first substantive contribution to the Party or the Mediation, or at the beginning of the Mediation if the Assistant is already engaged by the Party at that time.

No Party shall fail, for any reason, to disclose any assistance provided to them or any of their Assistants, for any reason. Except in the most trivial of circumstances, any person or group assisting the Party, or assisting an Assistant of a Party, must be registered as an Assistant in the Mediation.

Ex parte Conferences and Related Communications: The Mediator and the Administrator are authorized to conduct separate or ex parte meetings and other communications with the Parties and/or their Assistants, before, during, and after any Mediation. Such communications may be conducted via telephone, in writing, via email, online chat or video conference, in person, or otherwise.

Ex parte conferences and all related communications shall be kept Private and Confidential by all Mediators and Administrators unless otherwise agreed to by all participating Parties, Mediators, and Administrators.

Amendment of Nodes and Evidence: With unanimous consensus, the Parties may amend or supplement the Mediation's Claim, Reasons, or Objections while the Mediation is In Process, unless the Mediator considers it inappropriate to allow such amendment or supplement because of the delay in proposing it, decreased clarity, or for any other reason.

Parties may submit a Request for Amendment to the Mediator, to request an amendment to a Node which was Submitted by another Party. Such a Request for Amendment will include the reasons why the initiating Party wishes for the Node to be amended. Valid reasons include bias, loaded language, and many other valid reasons. The intention of the Request is not to refute or argue the Node, but to clarify its meaning. The Mediator may consider the Request and may act accordingly. The Mediator may negotiate the change with the Party who originally Submitted the Node and any or all other Parties to the Mediation. The decision of the Mediator may be final.

In embodiments of the Rules, No Party may be permitted to amend or supplement a Claim, Reason, or Objection if the amendment or supplement would cause the Claim, Reason, or Objection to fall outside the scope of the Mediation.

During the In Process phase of a Mediation, all communications between Parties, the Mediator, and the Administrator shall be conducted via the Mediation Platform. A permanent, public record of these communications will be kept. Exceptions include Submissions, Submission Feedback, Submission Suggestions, and communications related to Requests for Amendment to Nodes communicated during the Submission negotiation process. These messages will be kept private and will be available for audit, should the need arise.

Notices: The Parties, the Mediator, and the Administrator may all agree to not communicate with each other outside of the Mediation Platform for the duration of the In Process phase of the Mediation.

Parties shall be immediately notified via email, text, or some other way, when new Nodes have been published on the Argument Map of the Mediation.

For the purpose of calculating a period of time for responses under these Rules, such periods shall begin to run when a Submission is Approved by the Mediator and its Node is therefore Published.

Impartiality and Selection of a Mediator: The Mediator may be appointed by the Administrator.

Mediators may be required to abide by the Model Standards of Conduct for Mediators in effect at the time a Mediator is appointed to a Mediation. Where there is a conflict between the Model Standards and any provision of these Rules, these Rules shall govern. Among other stipulations, the Standards require all Mediators to:
1. Decline a Mediation if the Mediator cannot conduct it in an impartial manner, and
2. Disclose, as soon as practicable, all actual and potential conflicts of interest that are reasonably known to the Mediator and could reasonably be seen as raising a question about the Mediator's impartiality.

Prior to accepting an appointment, Mediators may be required to make a reasonable inquiry to determine whether there are any facts that a reasonable individual would consider likely to create a potential or actual conflict of interest for the Mediator. Mediators may be required to disclose any circumstance likely to create a presumption of bias or prevent a resolution of the Parties' dispute within the time frame desired by the Parties. Upon receipt of such disclosures, the Administrator may immediately communicate the disclosures to the Parties for their comments.

Disclosure by a Mediator or Party may not necessarily indicate belief by the Mediator or Party that the disclosed information gives rise to justifiable doubts as to the Mediator's impartiality or independence.

Failure of a Party to disclose any circumstances that may give rise to justifiable doubts as to a Mediator's impartiality or independence within a reasonable period after the Party becomes aware of such information constitutes a waiver of the right to challenge a Mediator based on those circumstances.

The Parties may, upon receiving disclosure of actual or potential conflicts of interest of the Mediator, waive such conflicts and proceed with the Mediation. In the event that a Party disagrees as to whether the Mediator shall serve, or in the event that the Mediator's conflict of interest or potential conflict of interest might reasonably be viewed as undermining the integrity of the Mediation, the Mediator may be replaced.

Challenge of a Mediator: A Party may Challenge a Mediator whenever circumstances exist that give rise to justifiable doubts as to the Mediator's impartiality or independence. In embodiments of the Rules, a Party shall send a written notice of the Challenge to the Administrator within 2 days after the circumstances giving rise to the Challenge, or within 2 days of the appointment of the Mediator. The Challenge shall state the reasons for the challenge.

Upon receipt of such a Challenge, the Administrator shall notify the other Party or Parties to the Mediation and give such Party an opportunity to respond. The Administrator may advise the challenged Mediator of the Challenge and request information from the challenged Mediator relating to the Challenge. When a Mediator has been challenged by a party, the other party may agree to the acceptance of the Challenge and, if there is agreement, the Mediator shall withdraw. The challenged Mediator, after consultation with the Administrator, also may withdraw in the absence of such agreement. In neither case does withdrawal imply acceptance of the validity of the grounds for the Challenge.

If the other Party or Parties do not agree to the Challenge or the challenged Mediator does not withdraw, the Administrator in its sole discretion shall make a determination regarding the Challenge.

The Administrator, in its sole discretion, may remove a Mediator for failing to perform his or her duties.

Replacement of a Mediator: If a Mediator resigns, withdraws, is incapable of performing their duties, or is removed for any reason and the office becomes vacant, a substitute Mediator shall be appointed by the Administrator. If a substitute Mediator is appointed, unless the Parties otherwise agree, the newly appointed Mediator shall determine at its sole discretion whether all or part of the Mediation shall be reviewed and/or amended.

Vacancies: If any Mediator shall become unwilling or unable to serve, the Administrator will appoint another Mediator. If any Administrator shall become unwilling or unable to serve, the platform provider will appoint another Administrator.

Consolidation: In the case that one platform Mediation depends upon another platform Mediation for Evidence or for any other reason, the Mediator of the dependent Mediation may temporarily suspended that Mediation, pending completion of the other platform Mediation. Such a suspension will last no longer than one (1) month, if at all possible.

Submissions, Evidence, and Comments: Submissions can be for Objection Nodes (in which case they are said to be Objecting) or Reason Nodes (in which case they are said to be Supporting). Objection Nodes weaken or contradict the message of their Parent Node. Reason Nodes support the meaning of their Parent Node.

Parties to an In Process Mediation will submit Submissions, with optional attached Evidence, in order to define and share their perspectives. When a Party submits a Submission, it will be evaluated by the Mediator for inclusion in the Mediation's Argument Map. The Mediator's general guidelines for assessing the acceptability of Submissions in embodiments of the Rules are:
1. Submissions must be reasonably credible and relevant to the Claim and/or the Submission's intended Parent Node.
2. Submissions must be neutral and objective in both words and tone.
3. Obscene or otherwise morally objectionable submissions shall not be allowed.
4. Submissions should not be redundant in their purpose.
5. Objecting Submissions should be submitted within the time-frame specified in these Rules or in the Agreement to Mediate, relative to the Publication of its intended Parent Node.

A Mediator may, at their sole discretion, Accept or Deny any Submission. When a Mediator denies a Submission, he or she will provide Submission Feedback to the Submitting Party, and may also optionally provide one or more pre-approved Submission Suggestions which the Mediator believes convey the same meaning as the original Submission, but in a more neutral, more clear, or otherwise more productive way.

Evidence attached to any Submission must adhere, in embodiments of the Rules, to the following:
1. Scientific evidence must be demonstrably observable, measurable, Falsifiable, and repeatable.
2. Obscene or otherwise morally objectionable evidence shall not be used, if at all reasonably possible.
3. The publication and/or representation of any and all Evidence on the Mediation Platform shall be subject to the approval of the platform provider.

Comments are submitted via Submissions to the Mediator and attached to the Nodes they are meant to clarify. Parties are expected to act in Good Faith in relating to the Comments made by other Parties.

### Time-frames for Objecting Submissions and Supporting Submissions

All newly Published Submissions must be responded to by all other Parties within the time-frame specified in the Terms of the Mediation.

Objecting Submissions will be submitted to the Mediator within one (1) business day of gaining access to the other Parties' approved Submissions, where the Objecting Submission is intended to be an Objecting Child Node. Parties may request from the Mediator extensions of up to one (1) week for Submissions which are overly complex, such as those which include scientific studies. These time-frames may be amended, in writing, at any time, by consent of all Parties. Reasonable exceptions and extensions to agreed time-frames will be made by the Mediator, at its sole discretion. These time-frames may be changed in the Terms of the Mediation.

The time-frame for submitting an Objecting Submission is one (1) business day after Publication of the Objecting Submission's intended Parent Node. Submissions will abide by the Terms of the Mediation regarding the Throttling of Submissions, so as to limit the number of new Submissions which other Parties will be required to respond to within a given time-frame.

The Proceedings of a Mediation: Subject to these Rules, the Mediator may conduct the Mediation in whatever manner he or she considers appropriate, provided that the Parties are treated equally and that each Party has an opportunity to declare their complete perspective—while honoring brevity and efficiency—and is given a fair opportunity to present its perspective, taking into account the circumstances of the Mediation, the wishes of each Party, and the need for an effective, timely and efficient conclusion to the Mediation. The Mediator is authorized to conduct both joint and separate meetings with the Parties. If requested, the Mediator may make oral or written recommendations in the form of Submission Suggestions or in other ways. In all cases, recordings will be made available unless otherwise explicitly agreed in the Terms of the Mediation.

The Parties shall make every effort to avoid unnecessary delay and expense during the Mediation process. The Mediator may draw adverse inferences, and may take such additional steps he or she deems necessary to protect the efficiency—in both time and cost—and the integrity of the Mediation.

After the Administrator appoints a Mediator and the Mediator has conducted any initial conferences with the Parties, the Mediation is considered to be “In Process”. At this time, the official Argument Map of the Mediation will be created. If there was a Preliminary Argument Map attached to the original Request to Mediate, part or all of that may be used as the initial official Argument Map, at the sole discretion of the Mediator.

At this time, all Parties have been granted access to submit Submissions.

When a Mediation is In Process, Parties are invited to submit Submissions to the Mediator for approval. When the Mediator receives such Submissions from a Party, the Mediator will have one (1) business day to either Approve or Deny the Submission. This time-frame may be modified in the Terms of the Mediation.

In the case when the Mediator approves the Submission, the Submission will be added, as-is, to the Mediation's Argument Map. At that time, it will be visible to all other Parties to the Mediation, and to the public. When a Node is first added to the Argument Map, all Parties have one (1) business day to submit a Request for Amendment if they have any desire to have the new Node amended. If there is no such Request, or after an amendment is Negotiated between the Parties, the Node will be considered a Completed Node and will no longer be available for amendment.

In the case when the Mediator Denies the Submission, the Submitting Party will receive Submission Feedback about whatever issues the Mediator found unacceptable. Included in the Submission Feedback, the Submitting Party may also receive one or more Submission Suggestions. The Submitting Party may then either select one of the Submission Suggestions, if any exist, for immediate Publication and inclusion in the Argument Map. Alternatively, the Submitting Party may choose to submit an amended version of the original Submission. The record of these negotiations will be kept secret but will be available for audit should the need arise.

After new Submissions are first Published, all other Parties to the Mediation are required to respond, within the time-frame specified in the Agreement to Mediate, with Agreement or Disagreement regarding the newly published Node. Parties are expected to Agree with Nodes which they themselves have created, with the exception of Preliminary Argument Maps, where Placeholder Nodes contain the public statements of others (i.e., public figures, domain experts, and/or thought leaders). Parties are obliged to submit, within the time-frame specified by these Rules or in their Agreement to Mediate, all of their Objecting Submissions relevant to the intended Parent Node. Parties may not express disagreement without providing reasons, expressed as an Objecting Child Node.

All decisions by the Mediator to either Approve or Deny Submissions will be final. This process will continue, with Parties submitting Submissions, until the end of the In Process phase of the Mediation.

Preliminary Argument Maps: When a Claimant submits a Request for Mediation, a Preliminary Argument Map may be included in their Request. In embodiments of the rules, it may not be permissible for a Party to a Mediation to create a Node with which they themselves Disagree. However, a Preliminary Argument Map may contain Placeholder Nodes which include Evidence of the assertions of other Thought Leaders, and with which the Claimant Disagrees.

Such Placeholder Nodes are meant to forward a meaningful Good Faith Argument Map. Upon Publication of the Preliminary Argument Map, any referenced Thought Leaders, if they are still living, will be Invited Parties to the Mediation. If they are not living, or if they are otherwise unable to provide their perspective, then a Proxy Thought Leader will be sought to represent the views of the original Thought Leader. The Invited Party will be asked to Verify or Edit those Nodes so that those Nodes more accurately represent the Thought Leader's current perspective on the topic of the Placeholder Node. Through this process, Placeholder Nodes may become accepted as Published Nodes.

The Expert Cohort is a group of people with specific credentials, or otherwise objective attributes relevant to the Claim of a Mediation. The specific criteria defining the Expert Cohort may either be agreed upon by all Parties to a Mediation, they may be assembled by a single Party, or they may be organized by another entity, entirely unrelated to the Mediation in question.

Voting by the Expert Cohort: An Expert Cohort may be validated and verified through a thorough vetting process so that each member of the Expert Cohort may be trusted to be authentic in their identity. The identities of all members of an Expert Cohort may be known to the public.

The intent of gathering an Expert Cohort is to have them Vote on each Completed Node in an Argument Map. The goal of this is to create the most complete description of the perspective of a community around an Argument Maps' primary Claim and related assertions, evidence, arguments, and ideas. Votes are one of these values: No Vote, Agree, Disagree, or Conclusive. Conclusive votes indicate that the Voter not only agrees with the Node, but that the Voter believes that the Node conclusively resolves any doubt about at least one of its Parent Nodes.

The values of all Votes, the identities of the Voter who cast them, and the date and time when they were cast, may be published and open to the public.

Disqualification as a Witness or Party: The Parties may not call the Mediator, the Administrator, or any other platform employee or agent as a witness or as an Assistant in any platform Mediation.

Responsibilities of the Parties: The Parties and their Representatives shall exercise their best efforts to prepare for and engage in an expeditious, meaningful, and productive Mediation.

The Mediation Platform and these Rules are all designed to support effective and efficient collaboration in building a greater accuracy in understanding and empathy between individuals and groups. Towards those ends, the Rules define these expectations regarding how Parties interact in Mediations.

Parties and their Assistants are expected to follow these guidelines in Good Faith.
1. Be respectful of everyone at all times and in all of their Submissions, conferences, Comments, and other communications.
2. Take special care with those who hold perspectives counter to their own.
3. Use objective, accurate, and neutral language when engaging in Mediations. Avoid argument styles which inflame rather than contribute to clarity and collaboration.
4. Employ Term Definitions whenever a term might be unclear or misunderstood.
5. Cooperate with the Mediator's concerns, as expressed via Submission Feedback and elsewhere.
6. Hold all confidential materials as confidential, as described in the Agreement to Mediate document.

Parties found by a Mediator or an Administrator to be acting outside of Good Faith in following these guidelines may be subject to adverse inferences drawn by the Mediator, Administrator, or the platform provider, corrective action, including expulsion from the Mediation and the Mediation Platform.

Privacy and Confidentiality: The Platform Argument Maps, along with their related Claims, Nodes, Evidence, Submissions, Submission Feedback, Submission Suggestions, Comments, and other related information, are created expressly for the purpose of the public good and shall therefore be neither Private nor Confidential. The same is true of any text, images, or any other documents or communications uploaded to or entered into the Mediation Platform by any Party in any way.

Exceptions to this rule are Negotiations regarding the processing of Invited Parties, and Negotiations regarding Submissions. Submissions, Submission Feedback, Submission Suggestions, and communications around Requests for Amendment may include divisive and more unclear language. As a result, the final, accepted Node is intended to represent those conversations in the most productive way possible.

Ex parte conferences, and any related communications which have not been entered into the Mediation Platform in any way, shall be kept private and confidential by the Mediator and the Administrator, unless otherwise required by law or judicial decision. Private recordings may be kept for auditing purposes.

Termination or Conclusion of the Mediation: The Mediation shall be completed when one or more of the following conditions exist:
1. All Parties Agree about the Mediation's Claim.
2. All Parties declare their contributions to the Mediation to be complete.
3. All but one of the Parties withdraws from the Mediation.
4. The Mediator calls an end to the Mediation.

In the case where further clarity is wanted around the Claim of a Completed Mediation, another Request to Mediate may be submitted by any Party to the Mediation, or any qualified member of the public, naming as Invited Parties or Nominating Parties any or all of the Parties to the Completed Mediation, or any other acceptable Party or Parties.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for creating an argument map for an argument via an online mediation platform, the system comprising:
one or more hardware processors configured by machine-readable instructions to:
receive, via the online mediation platform, a request to mediate the argument from a claimant;
provide a crowdfunding interface configured to facilitate a crowdfunding campaign associated with the argument;
negotiate, via the online platform, selection of at least two parties to a mediation of the argument;
negotiate, via the online platform, compensation for one or more of the at least two parties;
negotiate, via the online platform, appointment of at least one mediator;
provide a submission interface configured to receive submissions of proposed argument nodes; and
provide a submission interface configured to allow the at least one mediator to accept, reject, or edit the submissions, argument map interface configured to display accepted and edited submissions as child nodes on the argument map.

2. The system of claim 1, wherein the request to mediate comprises a preliminary argument map.

3. The system of claim 1, wherein the crowdfunding interface configured to facilitate the crowdfunding campaign further comprises an interface configured to receive preferences from funders regarding one or more aspects of the mediation.

4. The system of claim 1, wherein the at least two parties comprise one or more of nominating parties and invited parties.

5. The system of claim 1, wherein the negotiating via the online platform further comprises negotiation of terms of a mediation of the argument.

6. The system of claim 1, wherein the submission interface is further configured to receive an instruction from the at least one mediator to close the mediation.

7. The system of claim 1, wherein the argument map interface is configured to publicly display a completed version of the argument map.

8. A method for creating an argument map for an argument via an online mediation platform, the method comprising:
receiving, via the online mediation platform, a request to mediate the argument from a claimant;
providing a crowdfunding interface configured to facilitate a crowdfunding campaign associated with the argument;
negotiating, via the online platform, selection of at least two parties to a mediation of the argument;
negotiating, via the online platform, compensation for one or more of the at least two parties; and
negotiating, via the online platform, appointment of at least one mediator;
providing a submission interface configured to receive submissions of proposed argument nodes; and
providing a submission interface configured to allow the at least one mediator to accept, reject, or edit the submissions; argument map interface configured to display accepted and edited submissions as child nodes on the argument map.

9. The method of claim 8, wherein the request to mediate includes a preliminary argument map.

10. The method of claim 8, wherein the crowdfunding interface configured to facilitate the crowdfunding campaign further comprises an interface configured to receive preferences from funders regarding one or more aspects of the mediation.

11. The method of claim 8, wherein the at least two parties comprise one or more of nominating parties and invited parties.

12. The method of claim 8, wherein the negotiating via the online platform further comprises negotiation of terms of a mediation of the argument.

13. The method of claim 8, wherein the submission interface is further configured to receive an instruction from the at least one mediator to close the mediation.

14. The method of claim 8, wherein the argument map interface is configured to publicly display a completed version of the argument map.

15. A non-transient computer-readable storage medium having instructions embodied thereon, the instructions being executable by one or more processors to perform a method for creating an argument map for an argument via an online mediation platform, the method comprising:
receiving, via the online mediation platform, a request to mediate the argument from a claimant;
providing a crowdfunding interface configured to facilitate a crowdfunding campaign associated with the argument;
negotiating, via the online platform, selection of at least two parties to a mediation of the argument;
negotiating, via the online platform, compensation for one or more of the at least two parties; and
negotiating, via the online platform, appointment of at least one mediator;
providing a submission interface configured to receive submissions of proposed argument nodes; and
providing a submission interface configured to allow the at least one mediator to accept, reject, or edit the submissions; argument map interface configured to display accepted and edited submissions as child nodes on the argument map.

16. The computer-readable storage medium of claim 15, wherein the request to mediate comprises a preliminary argument map.

17. The computer-readable storage medium of claim 15, wherein the crowdfunding interface configured to facilitate the crowdfunding campaign further comprises an interface configured to receive preferences from funders regarding one or more aspects of the mediation.

18. The computer-readable storage medium of claim 15, wherein the at least two parties comprise one or more of nominating parties and invited parties.

19. The computer-readable storage medium of claim 15, wherein the negotiating via the online platform further comprises negotiation of terms of a mediation of the argument.

20. The computer-readable storage medium of claim 15, wherein the submission interface is further configured to receive an instruction from the at least one mediator to close the mediation.
